(19) United States
(12) Patent Application Publication
(10) Pub. No.: US 2002/0154149 A1
(43) Pub. Date: Oct. 24, 2002

(54) System, method and computer program product for associative region generation and modification

(76) Inventors: Kiran Hebbar, Exton, PA (US); Ralph Pinheiro, West Chester, PA (US)

Correspondence Address: Venable, P. O. Box 34385, Washington, DC, 20043-9998, US

(21) Appl. No.: 09/840,304

(22) Filed: Apr. 24, 2001

(51) Int. Cl. G09G 5/00

(52) U.S. Cl. 345/681

(57) ABSTRACT

A system, method and computer program product for associative region generation and modification is disclosed. The present invention can include a method in a computer system for creating and modifying an associative region (AR), which can include selecting one or more multi-dimensional shapes in a graphics file; placing a seed point and finding bounding multi-dimensional shapes automatically; associating the multi-dimensional shape(s) with an AR, and assigning a formation operator. The method can include displaying the AR as the result of applying the formation operator, such as union, intersection or difference, to the boundary element with a fill pattern, and storing parameters related to AR functionality in the AR. An AR can be edited by modifying boundary elements or seed of the AR. After such editing, the AR can automatically update itself and its display. If an AR becomes disassociated, it can display visual highlighting to indicate disassociation. An AR can be copied and pasted without losing its dependencies on its seed points and boundary elements. In addition, associative regions with creation and modification capabilities can be embodied in a computer system and in a computer program product.

### BACKGROUND OF THE INVENTION

1. Field of the Invention

The present invention relates generally to systems and methods related to software image editors and other two-dimensional and three-dimensional computer graphics based applications. In particular, the present invention relates to the creation and modification of associative regions within graphics files.

2. Related Art

Regions in graphics files are two-dimensional planes or three-dimensional entities that have dependencies on their boundaries in relation to points, planes or entities contained within the boundaries. For example, a region could be formed from a square with a circle drawn inside the bounds of the square. A seed point could be placed inside the bounds of the square or inside the circle within the square. A seed point is a zero-area element that acts as a source from which an area or volume is flooded. Flooding fills an area or volume with a pattern or color starting with the seed point and spreading outward until one or more boundaries, such as, e.g. the external boundary of a plane or entity shape, a line or the interior boundary of a plane or entity shape that surrounds the seed point, are reached. The resulting patterned or colored “flood plain” is the area or volume of the region. The region would be the boundary of the square as it relates to the boundary of the circle and to the seed point. If the seed point is outside of the circle and within the square, the region is the area covered by the square, minus the area covered by the circle. Likewise, if the seed point is within the circle, the region would be the area covered by the circle, and does not include the interior of the square that lies outside of the circle.

Regions are useful for several reasons. A region can be used to calculate the area or volume of a plane or entity or a collection of planes and/or entities within the region automatically, as they relate to each other. Modifying the above example, if the circle is placed partly outside of the square, the area of the portion of the circle that still lies within the square's boundaries can be calculated automatically. Conventional regions are not able to update their area or volume calculations automatically if the region changes.

A region can also be visually patterned with industry standard or user defined symbology to indicate materials or properties of each plane or entity in an region, e.g., all the concrete in a building is identified by the same concrete pattern, and the area of the above square that does not include the circle could be identified with a pattern. A region can be visually hatched or color-filled to make the region stand out in a graphics file. However, if the region changes, the pattern cannot conventionally update itself to the new shape, size or orientation of the region.

Conventionally, regions are formed in one of two ways. The space inside of a single closed element, such as, e.g., a triangle, a sphere or a user-drawn closed shape, can be a region. Another conventional method of forming regions is to place a seed point inside of a closed, bounded area or volume and to flood the area or volume from the seed point to the nearest closed boundaries. Conventional regions formed in these two ways lack the ability to update themselves if one or more of their boundaries or seed points change.

Disassociation occurs when one or more of the boundary elements of an region is moved, resized or deleted, creating a non-bounded space or a non-overlapping intersection. Flooding would no longer be possible because the area or volume is not closed and would “leak”. Disassociation is problematic because the user expects the region to be at a particular location in their design. There may be several applications relying on the region to compute additional parameters such as enclosed areas, hatch patterns, fill patterns and geometry simplifications. The disassociation of the region will cause those applications to fail. Conventionally, identifying and correcting a disassociation is left up to the user. Conventional graphics programs do not alert the user to the fact that the region is now disassociated. Also, once a region has become disassociated, the user cannot conventionally re-associate the region by correcting the boundary problem. If the user even realizes that the region is now disassociated, the user in a conventional graphics program would have to delete the seed point and the region, and then close the space. If the user wishes to recreate the region, the user would then have to place a new seed point, reset the fill pattern and re-form the region.

Conventionally, once a region is created, it cannot be duplicated by selecting the region, copying, and then pasting the region. If a number of identically shaped regions are needed, the user would typically have to create each region separately, wasting time.

### SUMMARY OF THE INVENTION

A system, method and computer program product for associative region generation and modification is disclosed. An exemplary embodiment of the present invention can include a method in a computer system for creating and modifying an associative region, which can include selecting one or more multi-dimensional shapes in a graphics file; associating the multi-dimensional shape or shapes with an associative region, including storing a unique identifier of the multi-dimensional shape or shapes in the associative region, causing the multi-dimensional shape or shapes to become boundary elements of the associative region; and assigning a formation operator to the boundary element or elements.

In an exemplary embodiment, the method can further include displaying the associative region as the result of applying the formation operator to the boundary element with a hatch pattern, a fill-color or a fill pattern.

In an exemplary embodiment, the method can further include storing parameters in the associative region. These parameters can include a formation operator parameter indicating the operation by which the associative region is formed, a locate interior shapes parameter, or a locate interior text parameter.

In an exemplary embodiment, the method can further include editing an associative region by modifying a boundary element of the associative region; removing the display of the associative region; applying a formation operator indicated by the stored formation operator type to the boundary elements; and displaying the edited associative region with a hatch pattern, a fill-color or a fill pattern.

In an exemplary embodiment, the method can further include maintaining an association flag in the associative region indicating the association state of the associative region; determining if the associative region remains associated after editing by verifying that the associative region is still bounded by the boundary elements; setting the association flag to indicate association when the associative region is determined to be associated; and when the associative region is determined to be disassociated, setting the association flag to indicate disassociation and adding visual highlighting to the display of the associative region to indicate disassociation.

In an exemplary embodiment, editing can include adding a boundary element to the associative region, which can include adding the unique identifier of the boundary element to the associative region's stored list of boundary element identifiers; deleting a boundary element from the associative region, which can include determining if the boundary element is the only boundary element of the associative region, removing the unique identifier of the boundary element from the associative region's list of boundary element identifiers, if it is not the only boundary element of the associative region, or if the boundary element is the only boundary element of the associative region, removing the associative region from the graphics file; changing the location of a boundary element of the associative region; changing the size of a boundary element of the associative region; and notifying the associative region from the modified boundary element that the modified boundary element has been modified.

In an exemplary embodiment, the method can further include selecting an associative region; selecting each boundary element associated with the associative region; creating a new associative region with properties identical to the selected associative region and, for each of the selected boundary elements, creating a new boundary element identical to the selected boundary element, thereby making a copy of the selected boundary element; assigning a new, unique identifier to the copy of the each boundary element; and removing all previously stored unique identifiers from the new associative region and storing each new, unique identifier in the new associative region.

In an exemplary embodiment, the method can further include placing the new associative region elsewhere in the graphics file or into a different graphics file.

In an exemplary embodiment, the method can further include placing a seed point in the graphics file, and selecting one or more multi-dimensional shapes automatically such that the shape or shapes form a closed boundary surrounding the seed point; and the formation operator is the flooding operator.

In an exemplary embodiment, the method can further include associating the seed point with an associative region, including storing the seed point in the associative region; storing parameters in the associative region, including a formation operator parameter indicating that the associative region is formed with the flood method, a locate interior shapes parameter, and a locate interior text parameter; and displaying the associative region with a hatch pattern, a fill-color, or a fill pattern.

In an exemplary embodiment, the method can further include editing an associative region by modifying a seed point of the associative region; removing the display of the associative region; applying the flood method from the seed point to the associative region's boundary elements; and displaying the edited associative region.

In an exemplary embodiment, the method can further include maintaining an association flag in the associative region indicating the association state of the associative region; determining if the associative region remains associated after editing by verifying that the space bounded by the boundary elements remains closed; setting the association flag to indicate association when the associative region is determined to be associated; and when associative region is determined to be disassociated, setting the association flag to indicate disassociation, and adding visual highlighting to the display of the associative region to indicate disassociation.

In an exemplary embodiment, editing can include adding a seed point to the associative region's list of seed points; deleting a seed point from the associative region, which includes determining if the seed point is the only seed point of the associative region; if the seed point is not the only seed point of the associative region, removing the seed point from the associative region's list of seed points; removing the associative region from the graphics file when the seed point is the only seed point of the associative region; and changing the location of a seed point of the associative region, which includes automatically locating all of the boundary elements that combined form a smallest closed boundary surrounding the associative region's seed points, and when a boundary element is located that is not associated with the associative region, automatically associating the boundary element with the associative region.

In an exemplary embodiment, the method can further include selecting more than one multi-dimensional shapes in a graphics file; and the formation operator can include an intersection, a union, or a difference operator.

In an exemplary embodiment, the method can further include displaying the associative region as the result of applying the formation operator to the boundary elements with a hatch pattern, a fill-color or a fill pattern.

In an exemplary embodiment, the method can further include storing parameters in the associative region, including a formation operator parameter indicating the method by which the associative region is formed, a locate interior shapes parameter, and a locate interior text parameter.

In an exemplary embodiment, the method can further include editing an associative region by modifying a boundary element of the associative region; removing the display of the associative region; applying a formation operator by the stored formation operator type to the boundary elements; and displaying the edited associative region.

In an exemplary embodiment, the method can further include maintaining an association flag in the associative region indicating the association state of the associative region; determining if the associative region remains associated after editing by verifying that the associative region is still bounded by the boundary elements; setting the association flag to indicate association when the associative region is determined to be associated; and when the associative region is determined to be disassociated, setting the association flag to indicate disassociation and adding visual highlighting to the display of the associative region to indicate disassociation.

In an exemplary embodiment, editing can include adding a boundary element to the associative region, which can include adding the unique identifier of the boundary element to the associative region's stored list of boundary element identifiers; deleting a boundary element from the associative region, which can include determining if the boundary element is the only boundary element of the associative region, removing the unique identifier of the boundary element from the associative region's list of boundary element identifiers, if it is not the only boundary element of the associative region, or if the boundary element is the only boundary element of the associative region; removing the associative region from the graphics file; changing the location of a boundary element of the associative region; changing the size of a boundary element of the associative region; and notifying the associative region from the modified boundary element that the modified boundary element has been modified.

In an exemplary embodiment, the method can further include automatically calculating the associative region's area, when the associative region is two or automatically calculating the associative region's volume, when the associative region is three dimensional.

Another exemplary embodiment of the present invention can include a system that creates and modifies associative regions, where the system can include a processor; a memory coupled to the processor; an associative region creation and modification module executable on the processor operative to create and modify associative regions. In an exemplary embodiment, the associative region creation and modification module can include a shape selector operative to select a multidimensional shape in a graphics file, a boundary element associator that associates the multi-dimensional shape with an associative region, and a generator that forms an associative region from the multi-dimensional shape and a formation operator.

In an exemplary embodiment, the system can further include a parameter assignor that assigns and stores parameters of the associative region in the memory, where the parameters can include a formation operator parameter that indicates the method by which the associative region is formed, a locate interior shapes parameter, and a locate interior text parameter; and a display that displays the associative region with a hatch pattern, a fill-color or a fill pattern.

In an exemplary embodiment, the system can further include an editor operative to edit the associative region, where the editor can include a boundary element adder operative to add a boundary element to the associative region; a boundary element remover operative to delete a boundary element from the associative region; a boundary element mover operative to move a boundary element of the associative region; a boundary element resizer operative to change the size of a boundary element of the associative region; and a notification module that notifies the associative region when a boundary element has been modified.

In an exemplary embodiment, the system can further include a highlighter that visually highlights the associative region on the display when the associative region becomes disassociated, and that removes visual highlights when the associative region becomes re-associated.

In an exemplary embodiment, the system can further include an associative region selector operative to select an associative region and each boundary element associated with the associative region; a copier that creates a new associative region with properties identical to the selected associative region and, for each of the boundary elements, creates a new boundary element identical to the selected boundary element; an assignor that assigns a new, unique identifier to the copies of the selected boundary elements; the boundary element associator operative to remove all previously stored unique identifiers from the new associative region and to store each new, unique identifier in the new associative region; and a paster operative to place the new associative region into the same graphics file or a different graphics file.

In an exemplary embodiment, the system can further include a seed point adder operative to add a seed point to the associative region; a boundary element locator that finds and selects all shapes in the graphics file that together form a closest closed boundary around the seed point; and where the generator can form the associative region with a flood operation from the seed point to the selected shapes.

In an exemplary embodiment, the system can further include a seed point associator that associates the seed point with the associative region; and a parameter assignor that assigns and stores parameters of the associative region in the memory, including a formation operator parameter that indicates the method by which the associative region is formed, a locate interior shapes parameter, and a locate interior text parameter; and a display that displays the associative region with a hatch pattern, a fill-color or a fill pattern.

In an exemplary embodiment, the system can further include an editor operative to edit a seed point of the associative region, including a seed point adder operative to add a seed point to the associative region's list of seed points; a seed point remover operative to delete a seed point from the associative region; a seed point mover operative to change the location of a seed point of the associative region; an updater that automatically locates all of the boundary elements that, combined, form a smallest closed boundary surrounding the associative region's seed points and automatically associates a located boundary element with the associative region when the located boundary element is not previously associated with the associative region.

In an exemplary embodiment, the system can further include a highlighter that visually highlights the associative region on the display when the associative region becomes disassociated, and that removes visual highlights when the associative region becomes re-associated.

In an exemplary embodiment, the shape selector of the system can be operative to select more than one multi-dimensional shape and the generator can form associative regions with a union, an intersection or a difference formation operator and the multi-dimensional shapes.

In an exemplary embodiment, the system can further include a parameter assignor that assigns and stores parameters of the associative region in the memory, including a formation operator parameter that indicates the operation by which the associative region is formed, a locate interior shapes parameter, and a locate interior text parameter; and a display that displays the associative region with a hatch pattern, a fill-color or a fill pattern.

In an exemplary embodiment, the system can further include an editor operative to edit the associative region, including a boundary element adder operative to add a boundary element to the associative region; a boundary element remover operative to delete a boundary element from the associative region; a boundary element mover operative to move a boundary element of the associative region; a boundary element resizer operative to change the size of a boundary element of the associative region; and a notifier that notifies the associative region that a boundary element has been modified.

In an exemplary embodiment, the system can further include a highlighter that visually highlights the associative region on the display when the associative region becomes disassociated, and removes visual highlights when the associative region becomes re-associated.

In an exemplary embodiment, the system can further include a calculator that automatically calculates an area or a volume of the associative region.

In another exemplary embodiment, a computer program product can be embodied on a computer readable medium. The computer program product can include program logic where the computer program product can include associative region creation and modification program code means for enabling a processor to create and modify associative regions, which can further include selecting means for enabling the processor to select a multi-dimensional shape in a graphics file; boundary element associating means for enabling the processor to associate the multidimensional shape with an associative region, and assigning means for enabling the processor to assign a formation operator to an associative region.

In an exemplary embodiment, the computer program product can further include storing means for enabling the processor to store parameters in the associative region, including a formation operator parameter indicating the operation by which the associative region is formed, a locate interior shapes parameter, and a locate interior text parameter; and displaying means for enabling the processor to display the associative region and to display a hatch pattern, a fill-color or a fill pattern.

In an exemplary embodiment, the computer program product can further include editing means for enabling the processor to edit the associative region, including boundary element adding means for enabling the processor to add a boundary element to the associative region; boundary element removing means for enabling the processor to delete a boundary element from the associative region; boundary element moving means for enabling the processor to move a boundary element of the associative region; boundary element resizing means for enabling the processor to change the size of a boundary element of the associative region; or notifying means for enabling the processor to notify the associative region that a boundary element has been modified.

In an exemplary embodiment, the computer program product can further include highlighting means for enabling the processor to visually highlight the associative region on the display when the associative region becomes disassociated, and to remove the visual highlights when the associative region becomes re-associated.

In an exemplary embodiment, the computer program product can further include selecting means for enabling the processor to select an associative region and each boundary element associated with the associative region; copying means for enabling the processor to create a new associative region with properties identical to the selected associative region and, for each of the boundary elements, to create a new boundary element identical to the boundary element; assigning means for enabling the processor to assign a new, unique identifier to the copies of the boundary elements; boundary element updating means for enabling the processor to remove all previously stored unique identifiers from the new associative region and to store each new, unique identifier in the new associative region; and pasting means for enabling the processor to place the new associative region into the same graphics file or a different graphics file.

In an exemplary embodiment, the computer program product can further include seed point adding means for enabling the processor to add a seed point to the associative region; boundary element locating means for enabling the processor to find and select all shapes in the graphics file that together form a closest closed boundary around the seed point, where the selected shapes are associated with the associative region by the boundary element associating means; and where the formation operator can include a flood operation from the seed point to the selected shapes.

In an exemplary embodiment, the computer program can further include seed point associating means for enabling the processor to associate the seed point with the associative region; and storing means for enabling the processor to store parameters in the associative region, including a formation operator parameter indicating the operation by which the associative region is formed, a locate interior shapes parameter, and a locate interior text parameter; and displaying means for enabling the processor to display the associative region with a hatch pattern, a fill-color or a fill pattern.

In an exemplary embodiment, the computer program product can further include editing means for enabling the processor to edit a seed point of the associative region, including seed point adding means for enabling the processor to add a seed point to the associative region's list of seed points; seed point removing means for enabling the processor to delete a seed point from the associative region; seed point moving means for enabling the processor to change the location of a seed point of the associative region; and updating means for enabling the processor to automatically locate all of the boundary elements that combine to form a smallest closed boundary surrounding the associative region's seed points and to automatically associate a located boundary element with the associative region when the located boundary element is not previously associated with the associative region.

In an exemplary embodiment, the computer program product can further include highlighting means for enabling the processor to visually highlight the associative region on the display when the associative region becomes disassociated, and to remove the visual highlights when the associative region becomes re-associated.

In an exemplary embodiment, the formation operator of the computer program product can include a union, an intersection or a difference operation.

In an exemplary embodiment, the computer program can further include storing means for enabling the processor to store parameters in the associative region, including a formation operator parameter indicating the operation by which the associative region is formed, a locate interior shapes parameter, and a locate interior text parameter; and displaying means for enabling the processor to display the associative region with a hatch pattern, a fill-color or a fill pattern.

In an exemplary embodiment, the computer program product can further include editing means for enabling the processor to edit the associative region including boundary element adding means for enabling the processor to add a boundary element to the associative region; boundary element removing means for enabling the processor to delete a boundary element from the associative region; boundary element moving means for enabling the processor to move a boundary element of the associative region; boundary element resizing means for enabling the processor to change the size of a boundary element of the associative region; or notifying means for enabling the processor to notify the associative region that a boundary element has been modified.

In an exemplary embodiment, the computer program product can further include highlighting means for enabling the processor to visually highlight the associative region on the display when the associative region becomes disassociated, and to remove the visual highlights when the associative region becomes re-associated.

In an exemplary embodiment, the computer program product can further include calculating means for enabling the processor to automatically calculate an area or a volume of the associative region.

In yet another exemplary embodiment of the present invention, a computer-readable medium containing a data structure for storing an associative region can include a boundary element identifier list containing an entry for each boundary element associated with an associative region, where each entry can contain a unique identifier for a boundary element; a seed point list containing an entry for each seed point of the associative region; and a formation operator parameter containing a constant indicating the formation operation used to generate the associative region.

In an exemplary embodiment, the data structure can further include an association_on flag containing a Boolean value to indicate an association state; an interior_shapes flag containing a Boolean value to indicate whether interior shapes should be ignored when generating the associative region; and an interior text flag containing a Boolean value to indicate whether interior text should be ignored when generating the associative region.

An associative region according to the present invention improves on conventional regions by retaining enough information about the associative region that the associative region can be modified without having to delete it and recreate it every time the user wishes to make a modification. Advantageously, the present invention also allows a user to create an associative region from the intersection, union or difference operation on two or more graphical elements.

The present invention can also automatically update an associative region when the region's boundary elements change. The automatic update occurs when one or more boundary elements is added to or deleted from the associative region, or are relocated or resized. The user does not have to delete and recreate the pattern, hatching or fill-color of an associative region because the pattern, hatching or fill-color can be automatically updated.

The ability of the present invention to automatically update an associative region extends to the ability to automatically update the area or volume of a region. If, for example, an associative region formed by the intersection of two shapes is modified by moving one of the shapes, the area of the intersection would also be modified, and the associative region could automatically calculate the adjusted area.

When the associative region changes shape due to the movement of its boundary elements, the pattern can automatically adjust itself to fill only the new shape. The pattern can also be set so that it scales with the associative region when the associative region is enlarged or shrunk. The pattern can also be set to rotate orientation with the associative region when the associative region is rotated, thereby saving the user from having to reset the pattern with every region change.

When one or more boundary elements change and the associative region becomes disassociated, the present invention displays visual feedback to the user that the region is now disassociated. In a preferred embodiment, the visual feedback can be in the form of a border drawn in color and style which contrasts with the background and existing geometry, such as, e.g. thick white and dashed lines when the displayed geometry is mixed colors on a dark background.

The user can correct the condition that caused a disassociation by moving a boundary element to close the associative region or relocating the seed point into a closed area. Upon correction, the present invention automatically updates the associative region with the boundaries and formation operator and removes any disassociation symbology from the display. The user does not have to delete the region or create a new region to effect the change.

Advantageously, the present invention allows the user to select an associative region, copy the region and place the copy into the same file or into a different file. The present invention preserves the dependencies in the copy, including the fill pattern and color and the boundary elements that define the region.

### BRIEF DESCRIPTION OF THE DRAWINGS

The foregoing and other features and advantages of the invention will be apparent from the following, more particular description of a preferred embodiment of the invention, as illustrated in the accompanying drawings. In the drawings, like reference numbers generally indicate identical, functionally similar, and/or structurally similar elements. The left most digits in the corresponding reference number indicate the drawing in which an element appears first.

FIG. 1A depicts a conventional embodiment of a region;

FIG. 1B depicts a second conventional embodiment of a region;

FIG. 1C depicts a third conventional embodiment of a region;

FIG. 2 depicts a block diagram of an associative region data structure and the data it contains;

FIG. 3A depicts an exemplary associative region created with the intersection operation;

FIG. 3B depicts an exemplary associative region created with the difference operation;

FIG. 3C depicts an exemplary associative region created with the union operation;

FIG. 3D depicts an exemplary associative region created by the seed point flooding operation;

FIG. 3E depicts a second exemplary associative region created by the seed point flooding operation;

FIG. 3F depicts a third exemplary associative region created by the seed point flooding operation;

FIG. 3G depicts a fourth exemplary associative region created by the seed point flooding operation;

FIG. 3H depicts an exemplary associative region created from several regions formed by the seed point flooding operation;

FIG. 3I depicts an exemplary associative region formed from a seed line flooding operation;

FIG. 4 depicts several limitations of regions which have been overcome by the present invention;

FIG. 5A depicts an exemplary embodiment of an automatic update of an associative region, according to the present invention;

FIG. 5B depicts an exemplary embodiment of visual feedback provided when disassociation occurs, according to the present invention;

FIG. 5C depicts a flowchart describing what happens when a user modifies the boundary elements in an associative region;

FIG. 6A depicts an exemplary embodiment of how a user can edit a seed point and the seed point's associative region according to the present invention;

FIG. 6B depicts a flow chart describing what happens when a user modifies a seed point in an associative region;

FIG. 7 depicts a block diagram of an exemplary system according to the present invention; and

FIG. 8 depicts an exemplary embodiment of a computer system that could be used in the present invention.

### DETAILED DESCRIPTION OF AN EXEMPLARY EMBODIMENT OF THE PRESENT INVENTION

A preferred embodiment of the invention is discussed in detail below. While specific exemplary implementation embodiments are discussed, it should be understood that this is done for illustration purposes only. A person skilled in the relevant art will recognize that other components and configurations may be used without parting from the spirit and scope of the invention. It is also important to realize that while the following figures show two-dimensional entities, the present invention can also include three-dimensional entities.

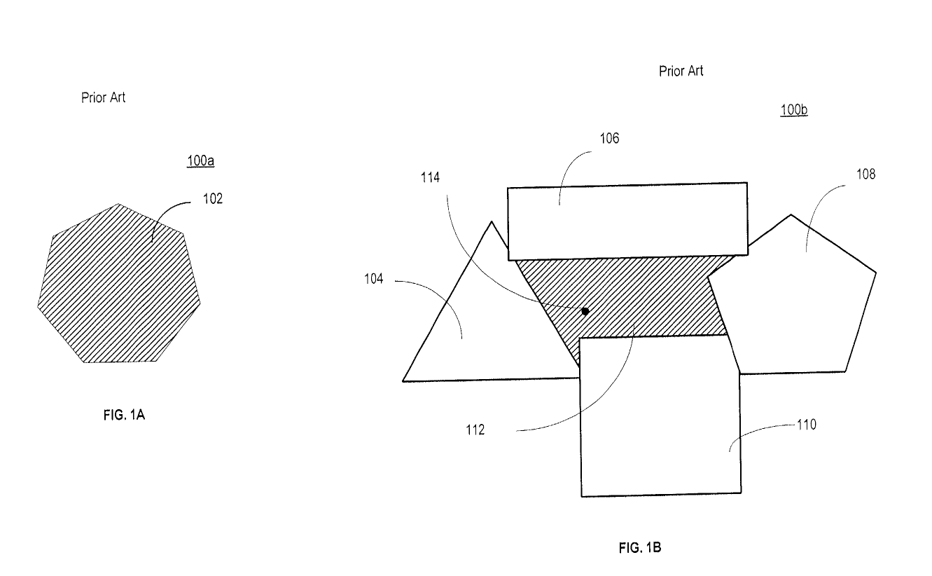

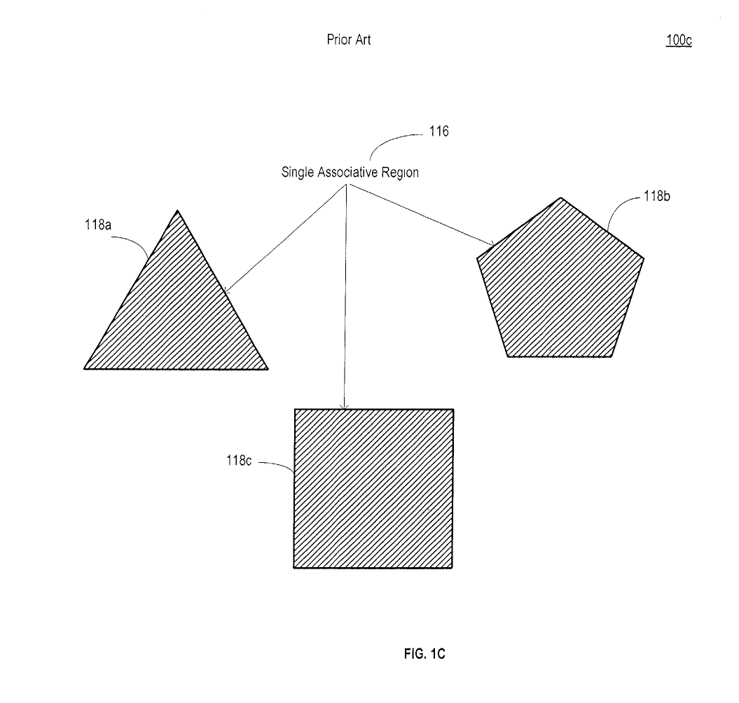

FIG. 1A depicts a conventional embodiment 100a of a region. Region 102 is simply the interior of a single closed shape. FIG. 1B shows a region 112 formed by flooding the space bounded by shapes 104-110 from the seed point 114. In neither case do the regions 102, 112 retain any information about the boundaries that define them or the method by which they are created.

FIG. 1C depicts a third conventional embodiment 100c of a region. Region 116 is formed from multiple disjoint regions 118a, 118b, 118c. Again, region 116 does not retain information about the boundaries of regions 118a-c nor of the operation that formed region 116.

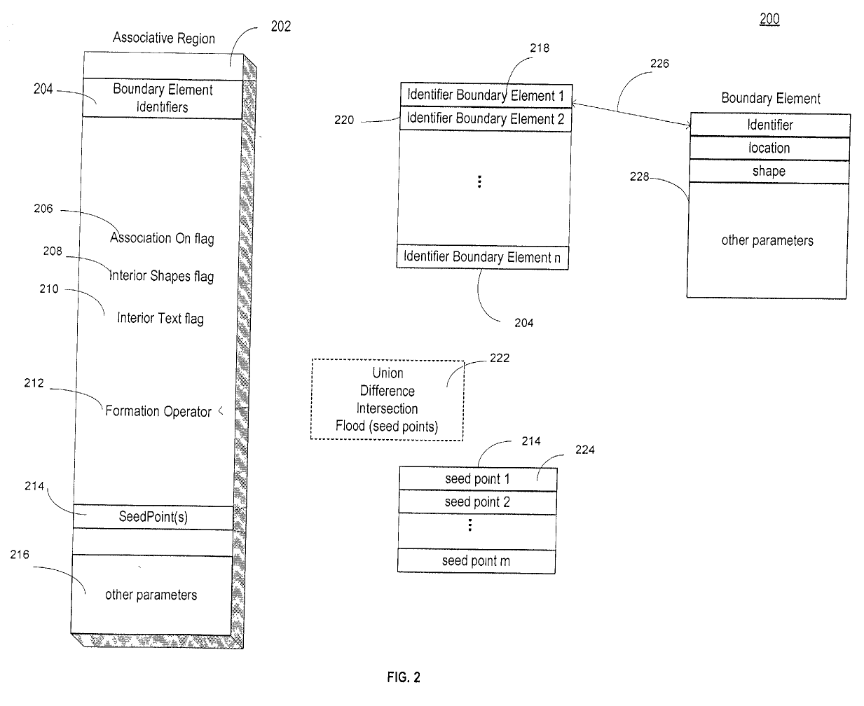

FIG. 2 depicts a block diagram 200 of an associative region data structure and the data the associative region contains. In an exemplary embodiment, of the present invention, an associative region 202 can store a number of data elements that are used in working with the associative region. Associative region 202 can keep track of how it is formed by storing its formation operator type 212. Formation operator type 212 indicates the operation by which the associative region is created. In an exemplary embodiment, these methods 222 can include seed point flooding, intersection, union, and difference. Associative region 202 can also store an association_on flag 206 to indicate if associative region 202 is currently associated. Associative region 202 can also store a list 204 of the unique object identifiers 218, 220 of the boundary elements that form associative region 202. The associative region 202 is coupled to the actual boundary element 228 by a dependency linkage 226 through the list 204. This dependency linkage allows the boundary element 228 to notify associative region 202, e.g. through a call-back, when boundary element 228 has been changed in some way. Associative region 202 can also store an interior_text flag 210 which indicates whether interior text should be considered in the associative region. If associative region 202 is created by the flood method, a seed points list 214 can be maintained by associative region 202. Seed point list 214 can contain all of the seed points 214, 224 that make up the region. Associative region 202 can store an interior_shapes flag 208 which indicates whether interior shapes should be considered in the flood region. Associative region 202 can also contain other parameters 216 for additional functionality.

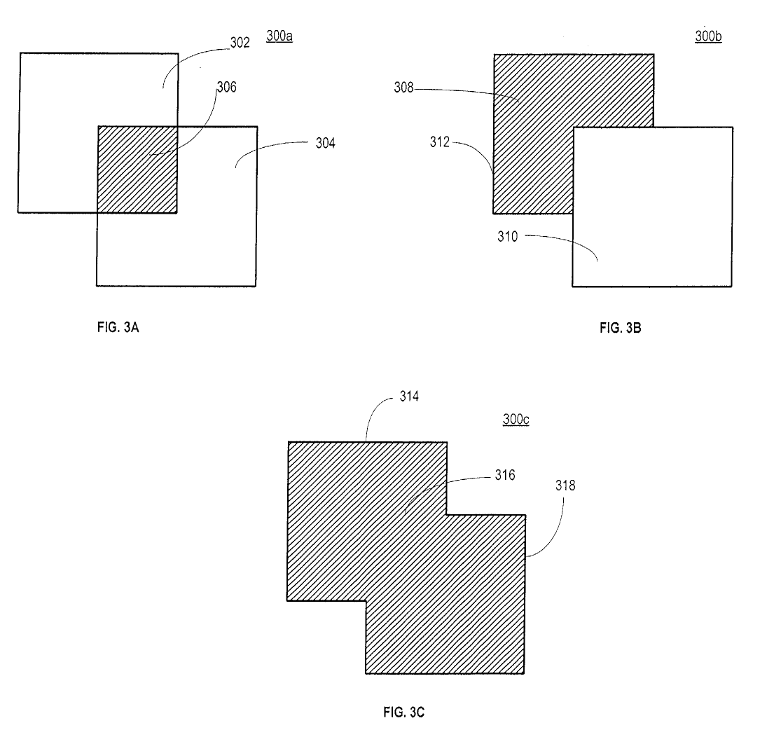

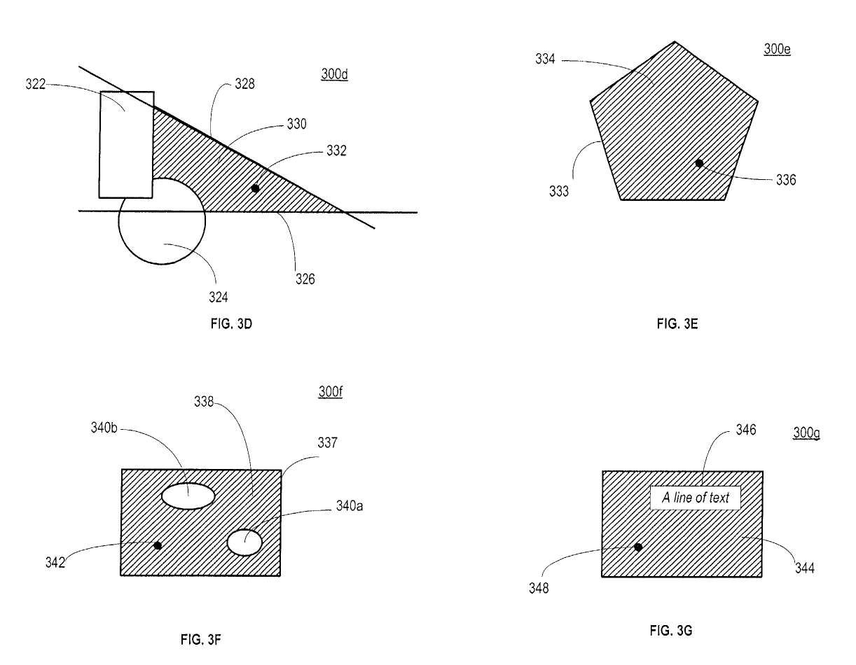

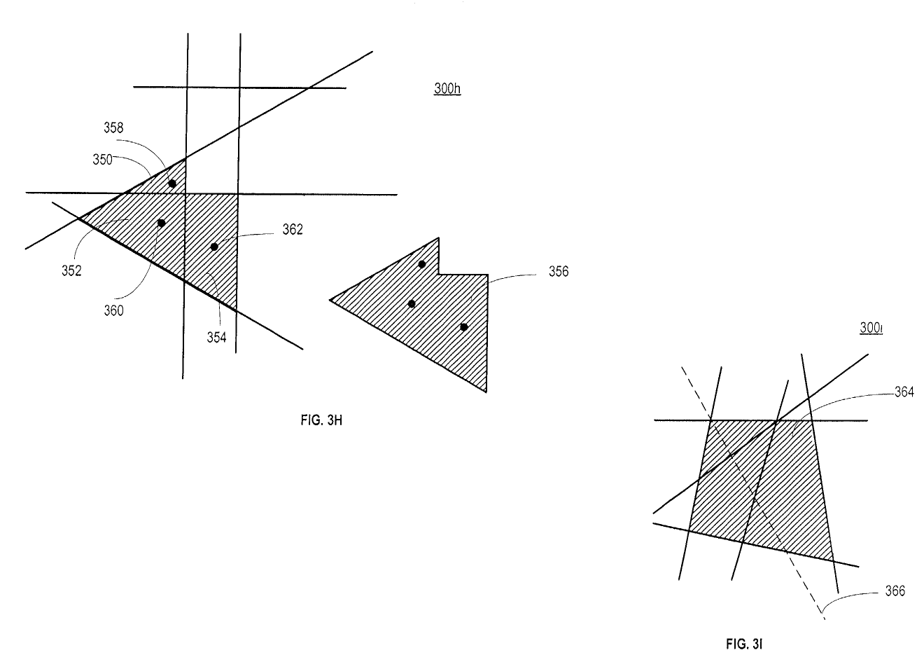

In FIG. 3A, an exemplary associative region is shown according to the present invention. Here, a user has selected shapes 302 and 304. The user then associates shapes 302 and 304 with a new associative region 306. The association is complete when the boundary element identifiers of shapes 302 and 304 are stored in associative region 306's boundary element list 204. The user then chooses the intersection formation operator and assigns it to associative region 306. Assigning the formation operator causes associative region 306's formation operator type 212 to be set to “intersection”. The user can then choose, for example, a hatch pattern and the associative region 306 can be displayed as the hatched area of the intersection of shapes 302 and 304. Associative region 306's association on flag would then be set to indicate association.

FIG. 3B shows associative region 308, which is formed in the same manner as associative region 306, only from the difference operation of shapes 312 and 310. As defined in set theory, the difference of two areas, X-Y, comprises the area that is in area X and not in area Y.

FIG. 3C shows associative region 316. In a different embodiment of the present invention, associative region 316 can be formed from the same steps as discussed in FIG. 3A, but in a different order. The user can first select shapes 314 and 318. Then the user can choose to form the union of shapes 314 and 318. From the union of shapes 314 and 318, the user can then choose to make an associative region. The new associative region can store the boundary element identifiers of shapes 314 and 318, and can store “union” as its formation operator type. In this different embodiment, the user can also choose intersection, and difference as formation operations.

FIGS. 3D-3G show four exemplary embodiments 300d-g of associative regions created by the seed point flooding operation. In FIG. 3D, associative region 330 is formed by first setting seed point 332. In one exemplary embodiment of the present invention, the closest shapes 322-328 that together form a bounded space around seed point 332 can be automatically determined. In a different exemplary embodiment, the user can explicitly select the closest bounding shapes. Once the boundaries are selected, the identifiers of those closest shapes are added to the associative region 330 thereby identifying boundary elements, and the area bounded by boundary elements 322-328 from seed point 332 is flooded with a fill pattern or color, and in this example, with a hatch pattern. In an exemplary embodiment, associative region 330 stores a list 204 of identifiers for boundary elements 322-328. Associative region 330's formation operator type 212 is “flood”. Seed point 332 is stored in associative region 330's seed point list 214.

In FIG. 3E, associative region 334 is formed by flooding a single closed shape 333 from seed point 336, storing the identifier of shape 333, storing “flood” as the formation operator parameter, and storing seed point 336. FIG. 3F shows associative region 338 which is formed by flooding closed shape 337 from seed point 342. Note that the associative region 338 does not include holes 340a, 340b, because associative region 338's interior_shapes flag is set to locate holes, i.e. not include the holes in the associative region. In FIG. 3G, associative region 344, formed from seed point 348 and closed shape 346 is analogous to associative region 334. Associative region 344 includes the area covered by text box 346, but does not hatch the text area, because associative region 344's interior_text flag is set to locate text, i.e. not hatch any text boxes.

FIG. 3H depicts an additional exemplary embodiment 300h of an associative region created by the flood operation according to the present invention. Associative region 356 is formed from multiple seed point flood areas 350, 352, 354. Seed points 358, 360 and 362 would be stored in associative region 356's seed point list 214, in an exemplary embodiment of the present invention. FIG. 31 shows associative region 364, which is formed by flooding an enclosed area from a seed-line 366. A seed line functions as a linear sequence of seed points. Only the portion of the seed line that lies within an enclosed space generates a flood area.

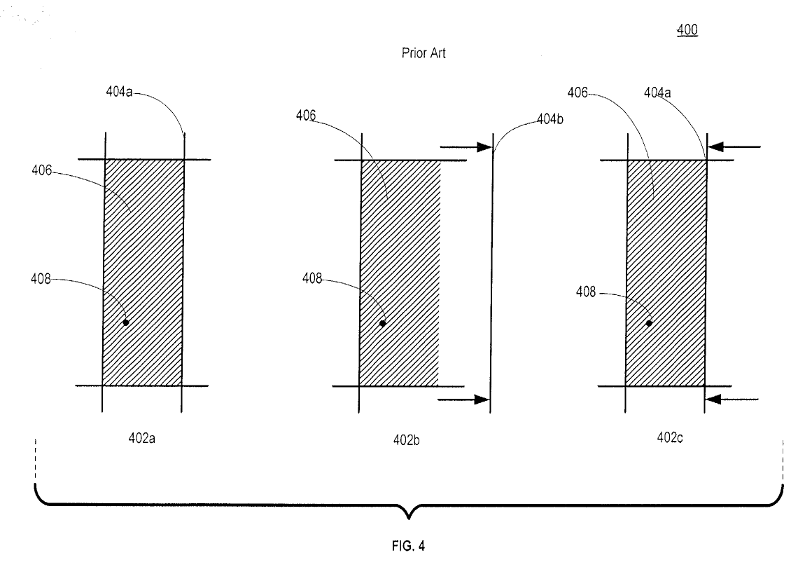

FIG. 4 depicts a diagram 400 of several limitations of associative regions which have been overcome by the present invention. The drawing at time step 402a depicts a conventional region 406 formed by flooding a bounded area from seed point 408. At time step 402b, boundary 404 has moved from position 404a to 404b. The seed point 408 is no longer in a bounded area, so region 406 is now disassociated.

There is no visual feedback to the user that the region 406 is no longer valid and that the region is disassociated. When line 404 is moved back to its previous position at time step 402c, the region 406 is not conventionally re-associated. There is also no visual indication to the user that the region 406 remains disassociated.

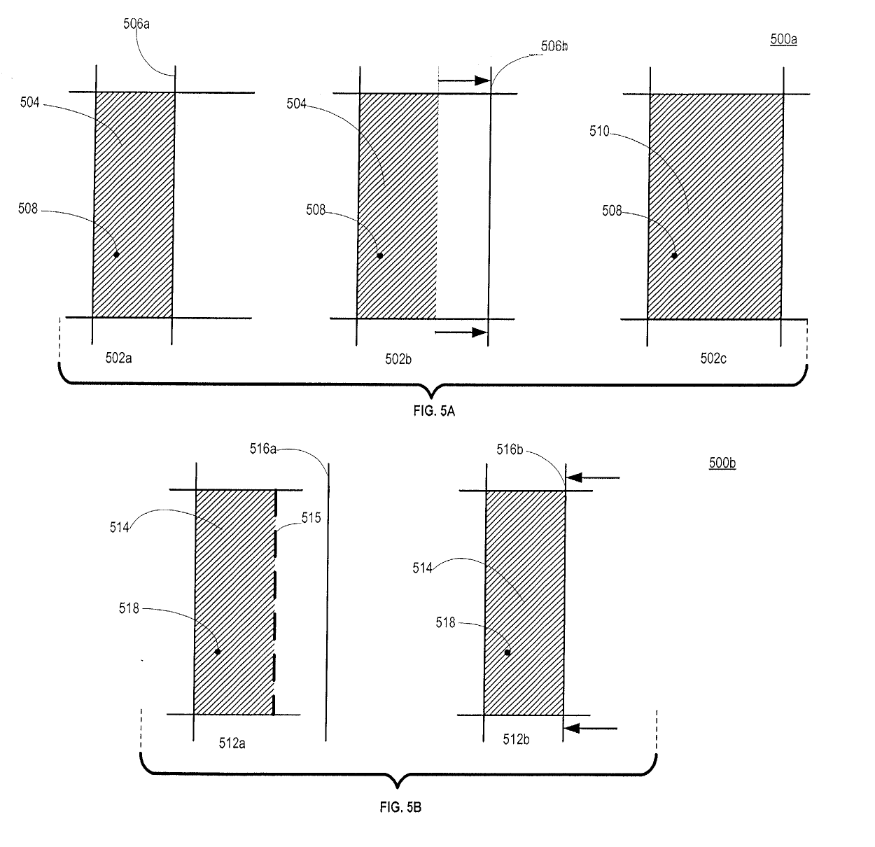

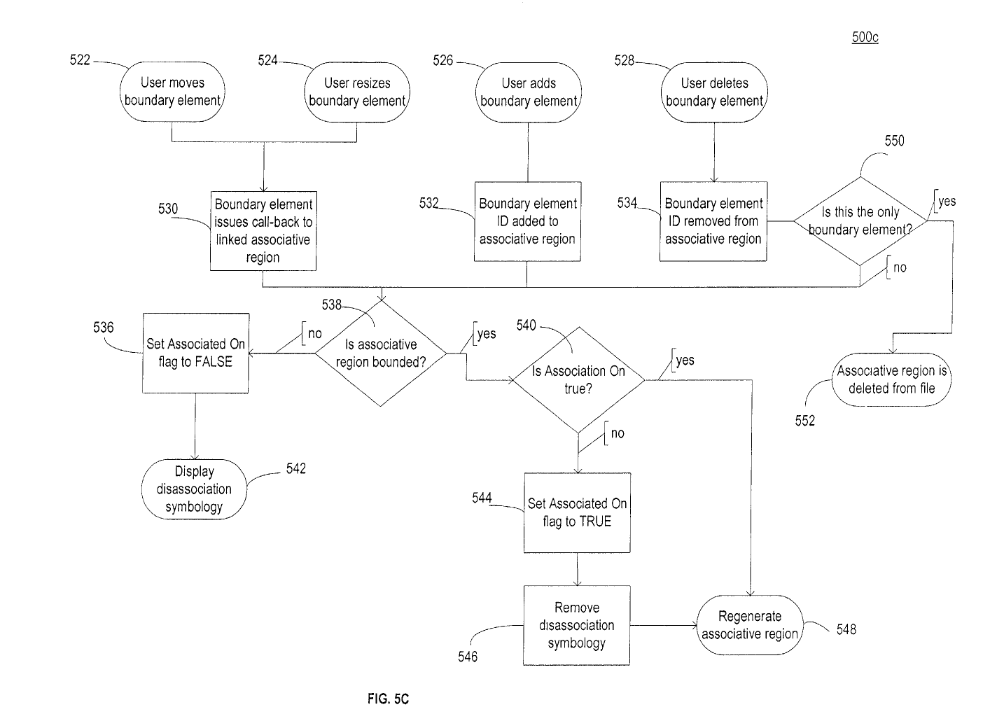

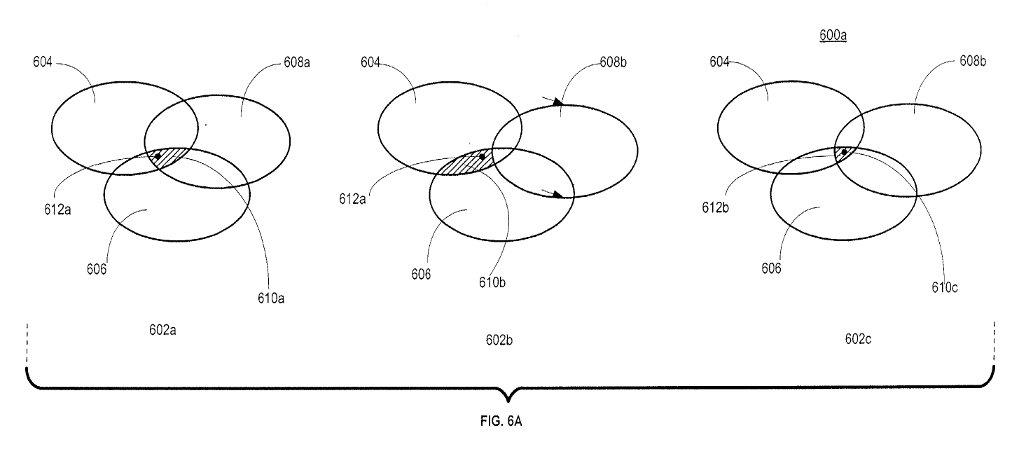

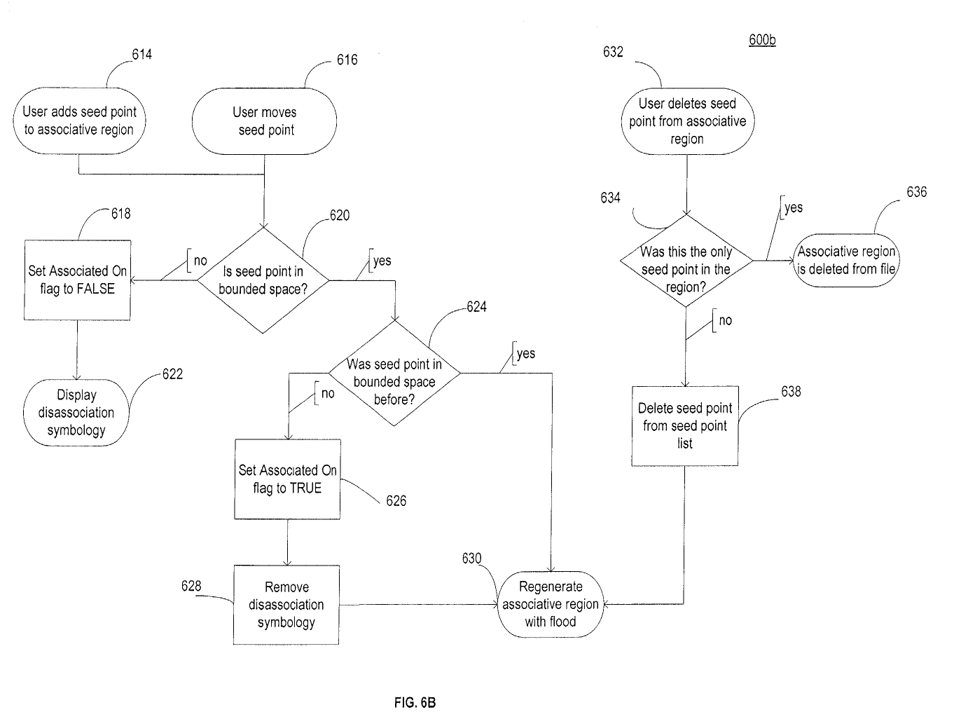

FIG. 5A shows an exemplary embodiment 500a of an automatic update of an associative region, according to the present invention. In the sequence of time steps 502a, 502b, 502c, the boundary 506a of associative region 504 moves to a new position at 506b. Boundary 506 updates, via call-back, the associative region 504 with which it is associated that boundary 506 has been modified. Associative region 504 then searches for the closest boundary elements from its seed point(s). After the search, associative region 504 then updates its list of boundary element identifiers, if new boundary elements are located or old ones are not longer applicable. Associative region 504 then re-floods the area from seed point 508 to those closest boundary elements. The newly updated associative region 510 is depicted at time step 502c.

FIG. 5B depicts an exemplary embodiment 500b of visual feedback provided when disassociation occurs, according to the present invention. At time step 512a, boundary element 516a has been moved away from associative region 514, causing disassociation. When the changed boundary element updates the associative region 514 with which it is associated that it has been modified, the associative region 514 attempts to automatically find its closest boundary elements. However, in this case, the region cannot find a set of boundary elements that completely encloses it. The association_on flag is set to indicate that the region is now disassociated. In an exemplary embodiment, of the present invention, the edge of the now disassociated region 514 is highlighted visually with disassociation symbology 515 to indicate to the user that the region is disassociated. At time step 512b, boundary element 516b has been moved to re-enclose the area where seed point 518 is located. In an exemplary embodiment, the change in the boundary element initiates an update to the associative region with which the boundary element is associated. The update, in turn, prompts the region 514 to attempt to update its list of boundary elements and redisplay itself. At time step 512b, the update of boundary elements is successful, meaning that a closed region is formed, so the flag indicating that the associative region is associated is set to indicate association. The region 514 updates itself automatically and is once again associated. Once updated, the disassociation symbology is removed from the region 514.

FIG. 5C depicts a flowchart 500c describing what happens when a user modifies the boundary elements in an associative region. When a user moves a boundary element in step 522 or resizes a boundary element in step 524, the modified boundary element notifies, via call-back, the region with which it is associated that it has changed, step 530. The associative region prepares to regenerate itself and checks that the region is still bounded in decision 538. If the region is not bounded, the region's association_on flag is set to indicate disassociation in step 536. The display is then updated with disassociation symbology in step 542. If the region is bounded, the associative region will check the value of its association_on flag in decision 540. If the association_on flag indicates association, the associative region regenerates in step 548. Regeneration involves removing any prior display of the region, then re-creating the associative region and its display according to the operation specified in the associative region's formation operator type. If the association_on flag indicates disassociation, it is set to indicate association in step 544. Then in step 546, the disassociation symbology is removed from display and the associative region regenerates in step 548 according to the method specified in the associative region's formation operator type.

When a user adds a new boundary element as in step 526 to an associative region, the identifier for that boundary element is added to the boundary element identifier list stored by the associative region in step 532. When a boundary element is deleted from an associative region as in step 528, if the deleted boundary element is not the only boundary element in the associative region, its identifier is removed from the associative region's list of boundary element identifiers. Steps 532 and 534 proceed to decision 538 as discussed above. If the boundary element is the only boundary element in the associative region, then the associative region is deleted from the file in step 552.

FIG. 6A depicts an exemplary embodiment 600a of how a user can edit a seed point and the seed point's associative region according to the present invention. At time step 602a, the user has placed seed point 612a in an intersection of shapes 604, 606 and 608a to create associative region 610a. When the seed point 612a is placed, the closest enclosing boundary elements are automatically identified and the area enclosed by those closest enclosing boundary elements is flooded with a hatch pattern. At time step 602b, the user has moved shape 608a to its new location 608b. In an exemplary embodiment, of the present invention, the associative region 610a is automatically updated according to the new boundaries to form associative region 610b. However, if the user does not want the new associative region 610b, the user can move the seed point 612a to a new location 612b as shown at time step 602c, according to the present invention. The associative region 612b automatically searches for its closest boundary elements from the new location of its seed point. The associative region 612b is displayed at its new location using the same hatch pattern previously assigned. Thus, the hatch pattern can follow the region to its new bounds and does not have to be reapplied. Conventionally, the user would have had to delete the seed point and the hatched region, then create a new seed point and hatching in the new area.

FIG. 6B depicts a flow chart 600b describing what happens when a user modifies the seed points of an associative region. When the user adds a seed point as in step 614 to an associative region, the seed point is added to the seed point list of the associative region. When a new seed point is added, or when the user moves a seed point to a new location as in step 616, the associative region checks if the new or moved seed point is in a bounded space, decision 620. If the seed point is not in bounded space, the association_on flag is set to indicate disassociation in step 618 because the region is disassociated. The display updates the region with disassociation symbology in step 622. If the new or moved seed point is in bounded space, the region checks the value of the association_on flag at decision 624. If the association_on flag indicates disassociation, it is set to indicate association in step 626. Then the disassociation symbology is removed in step 628. Then, or if the association_on flag already indicated association, the associative region regenerates itself with the flood operation from all of the seed points in its seed point list to the boundary elements in its boundary element identifier list in step 630.

When the user deletes a seed point from an associative region, in step 632, if the seed point was the only seed point in the region, the associative region is deleted from the file in step 636. If the deleted seed point was not the only seed point in the region, then the seed point is removed from the associative region's seed point list in step 638 and the associative region regenerates itself with the flood operation from all of the seed points in its seed point list to the boundary elements in its boundary element identifier list as in step 630.

One embodiment of the present invention allows the user to copy an associative region and place the copy elsewhere in the same file or in another file. The user selects the associative region and all of its boundary elements and chooses to copy the associative region. A new associative region having the identical properties of the selected associative region is formed. Then, for each of the selected boundary elements, a new boundary element having properties identical to the selected boundary element is formed. A new unique identifier is assigned to each new boundary element. The new unique identifiers are added to the boundary element identifier list of the new associative region. The new associative region can then be inserted into any file that supports its format.

In a different embodiment of the present invention, the user who wishes to copy an associative region needs only to select the associative region itself. When the user elects to copy the selected associative region, the associated boundary elements, seed points and associative region properties are automatically copied as described above without direct user involvement.

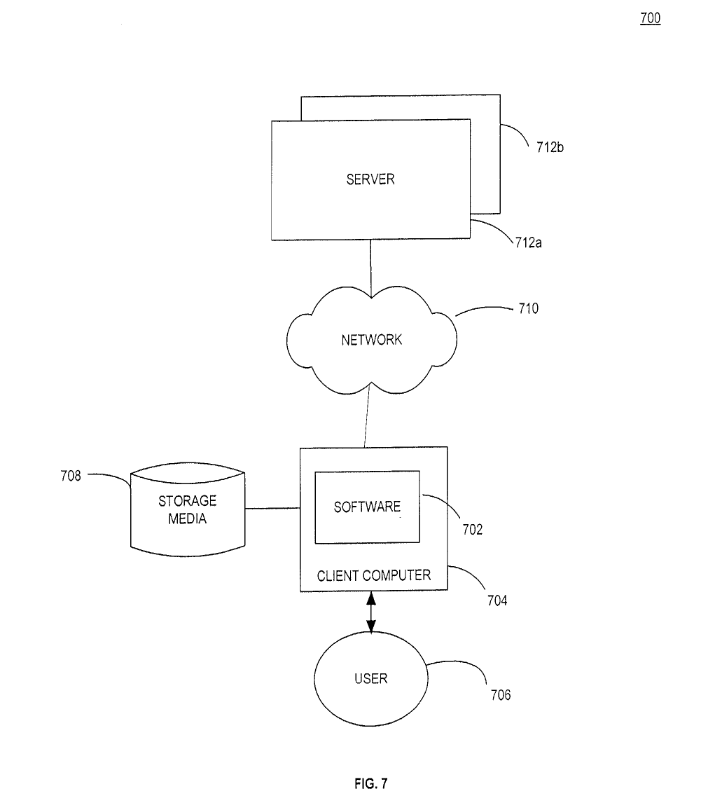

FIG. 7 depicts a block diagram 700 of an exemplary system according to the present invention. Block diagram 700 can include a user 706 interacting with a client computer 704 to access content on storage media 708 and servers 712a, 712b. Client computer 704 can include an operating system (not shown) and software application programs 702. Client computer 704 can be coupled in an exemplary embodiment to server 712a, 712b by network 710.

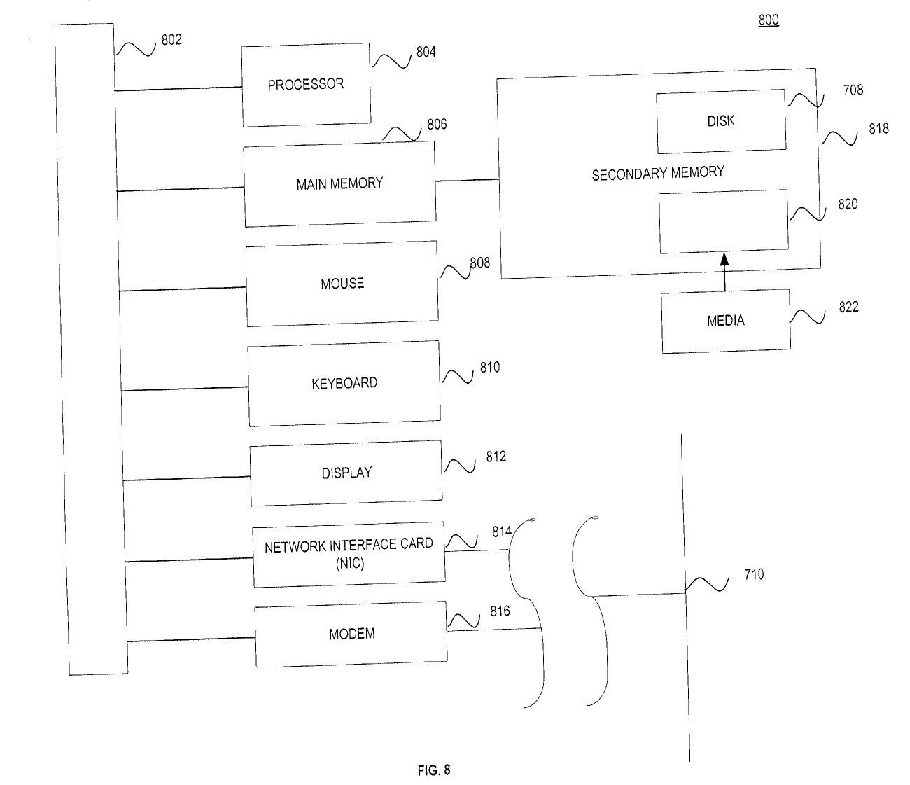

FIG. 8 depicts an exemplary embodiment of a computer system 800 that could be used in the present invention. Specifically, FIG. 8 illustrates an exemplary embodiment of a computer 702, 712 which in a preferred embodiment is a computer that can include, e.g., a personal computer (PC) system running an operating system such as, e.g., Windows NT/98/2000/CE, OS/2, MacOS, LINUX, or other variants of the UNIX operating system. However, the invention is not limited to these platforms.

The invention can be implemented on any appropriate computer system running any appropriate operating system, such as Solaris, Irix, Linux, HPUX, OSF, Windows 98, Windows NT, OS/2, MacOS, and any others, in addition to any electronic device capable of displaying lines on its screen. In one embodiment, the present invention is implemented on a computer system operating as discussed herein.

The computer 702, 712 includes one or more processors, such as processor 804. The processor 804 is connected to a communication bus 802.

The computer 702, 712 can also include a main memory 806, preferably random access memory (RAM), and a secondary memory 818. The secondary memory 818 can include, e.g., a hard disk drive 708, or storage area network (SAN) and/or a removable storage drive 820, representing a floppy diskette drive, a magnetic tape drive, a compact disk drive, etc. The removable storage drive 820 reads from and/or writes to a removable storage unit 822 in a well known manner.

Removable storage unit 822, also called a program storage device or a computer program product, represents a floppy disk, magnetic tape, compact disk, etc. The removable storage unit 822 includes a computer usable storage medium having stored therein computer software and/or data, such as an object's methods and data.

The computer 702, 712 also includes an input device such as (but not limited to) a mouse 808 or other pointing device such as a digitizer, and a keyboard 810 or other data entry device.

The computer 702, 712 can also include output devices, such as, e.g., display 812. The computer 702, 712 can include input/output (I/O) devices such as, e.g., network interface cards 814 and modem 816.

Computer programs (also called computer control logic), including object oriented computer programs, are stored in main memory 806 and/or the secondary memory 818 and/or removable storage units 822, also called computer program products. Such computer programs, when executed, enable computer 702, 712 to perform the features of the present invention as discussed herein. In particular, the computer programs, when executed, enable the processor 804 to perform the features of the present invention. Accordingly, such computer programs represent controllers of the computer system 804, 702, 712.

In another embodiment, the invention is directed to a computer program product comprising a computer readable medium having control logic (computer software) stored therein. The control logic, when executed by the processor 804, causes the processor 804 to perform the functions of the invention as described herein.

In yet another embodiment, the invention is implemented primarily in hardware using, e.g., one or more state machines. Implementation of these state machines so as to perform the functions described herein will be apparent to persons skilled in the relevant arts.

What is claimed is:

1. A method in a computer system of creating and modifying an associative region comprising:
(A) selecting at least one multi-dimensional shape in a graphics file;
(B) associating said at least one multi-dimensional shape with an associative region, including storing a unique identifier of said at least one multidimensional shape in said associative region, wherein said at least one multi-dimensional shape becomes a boundary element of said associative region; and
(C) assigning a formation operator to said boundary element.

2. The method according to claim 1, further comprising:
(D) displaying said associative region as the result of applying said formation operator to said boundary element with at least one of a hatch pattern, a fill-color and a fill pattern.

3. The method according to claim 1, further comprising:
(D) storing parameters in said associative region, wherein said parameters comprise at least one of
a formation operator parameter indicating the operation by which said associative region is formed,
a locate interior shapes parameter, and
a locate interior text parameter.

4. The method according to claim 3, further comprising:
(E) displaying said associative region as the result of applying said formation operator to said at least one boundary element with at least one of a hatch pattern, a fill-color and a fill pattern.

5. The method according to claim 4, further comprising:
(F) editing an associative region by modifying a boundary element of said associative region;
(G) removing said display of said associative region;
(H) applying a formation operator indicated by said stored formation operator type to said boundary elements; and
(I) displaying said edited associative region.

6. The method according to claim 5, further comprising:
(J) maintaining an association flag in said associative region indicating the association state of said associative region;
(K) determining if said associative region remains associated after editing by verifying that the associative region is still bounded by said boundary elements, therein remaining associated;
(L) when said associative region is determined to be associated, setting said association flag to indicate association; and
(M) when said associative region is determined to be disassociated, setting said association flag to indicate disassociation and adding visual highlighting to said display of said associative region to indicate disassociation.

7. The method according to claim 5, wherein:
(F) editing comprises at least one of:
i. adding a boundary element to said associative region, comprising
adding a unique identifier of said boundary element to said associative region's stored list of boundary element identifiers;
ii. deleting a boundary element from said associative region comprising
iia. determining if said boundary element is the only boundary element of said associative region;
iib. when said boundary element is determined not to be the only boundary element of said associative region, removing the unique identifier of said boundary element from said associative region's list of boundary element identifiers;
iic. when said boundary element is determined to be the only boundary element of said associative region, removing said associative region from said graphics file;
iii. changing the location of a boundary element of said associative region;
iv. changing the size of a boundary element of said associative region; and
v. notifying said associative region from said modified boundary element that said modified boundary element has been modified.

8. The method according to claim 1, further comprising:
(D) selecting an associative region;
(E) selecting each boundary element associated with said associative region;
(F) creating a new associative region with properties identical to said selected associative region and, for each of said selected boundary elements, creating a new boundary element identical to said each selected boundary element, thereby making a copy of said each selected boundary element;
(G) assigning a new, unique identifier to each of said copies of said each selected boundary elements; and
(H) removing all previously stored unique identifiers from said new associative region and storing each said new, unique identifier in said new associative region.

9. The method according to claim 8, further comprising:
(I) placing said new associative region elsewhere in said graphics file.

10. The method according to claim 8, further comprising:
(I) placing said new associative region into a different graphics file.

11. The method according to claim 1, wherein:
selecting at least one multi-dimensional shape further comprises placing a seed point in said graphics file, and said at least one multi-dimensional shape is automatically selected wherein said at least one multi-dimensional shape forms a closed boundary surrounding said seed point; and
the formation operator comprises a flooding operator, wherein the area from said seed point to said closed boundary completely enclosing said seed point is flooded with a fill pattern to said closed boundary.

12. The method according to claim 11, further comprising:
(D) associating said seed point with an associative region, including storing said seed point in said associative region; and
(F) storing parameters in said associative region, wherein said parameters comprise at least one of
a formation operator parameter indicating that said associative region was formed with the flood method,
a locate interior shapes parameter, and
a locate interior text parameter;
(F) displaying said associative region with at least one of a hatch pattern, a fill-color and a fill pattern.

13. The method according to claim 12, further comprising:
(G) editing an associative region by modifying a seed point of said associative region;
(H) removing a display of said associative region;
(I) applying said flood method from said seed point to said associative region's boundary elements; and
(I) displaying said edited associative region.

14. The method according to claim 13, further comprising:
(K) maintaining an association flag in said associative region indicating the association state of said associative region;
(L) determining if said associative region remains associated after editing by verifying that the space bounded by said boundary elements remains closed;
(M) when said associative region is determined to be associated, setting said association flag to indicate association; and
(N) when associative region is determined to be disassociated, setting said association flag to indicate disassociation, and adding visual highlighting to said display of said associative region to indicate disassociation

15. The method according to claim 13, wherein:
(G) editing comprises at least one of:
i. adding a seed point to said associative region's list of seed points;
ii. deleting a seed point from said associative region, comprising
iia. determining if said seed point is the only seed point of said associative region;
iib. removing said seed point from said associative region's list of seed points when said seed point is determined not to be the only seed point of said associative region;
iic. removing said associative region from said graphics file when said seed point is determined to be the only seed point of said associative region; and
iii. changing the location of a seed point of said associative region, comprising
iiia. automatically locating all of the boundary elements that, combined form a smallest closed boundary surrounding said associative region's seed points;
iiib. when a boundary element is located that is not associated with said associative region, automatically associating said boundary element with said associative region.

16. The method according to claim 1, wherein:
selecting further comprises selecting at least two multi-dimensional shapes in a graphics file; and
the formation operator comprises at least one of an intersection, a union, and a difference.

17. The method according to claim 16, further comprising:
(D) displaying said associative region as the result of applying said formation operator to said boundary elements with at least one of a hatch pattern, a fill-color and a fill pattern.

18. The method according to claim 16, further comprising:
(D) storing parameters in said associative region, wherein said parameters comprise at least one of
a formation operator parameter indicating the method by which said associative region is formed,
a locate interior shapes parameter, and
a locate interior text parameter.

19. The method according to claim 18, further comprising:
(E) displaying said associative region as the result of applying said formation operator to said boundary elements with at least one of a hatch pattern, a fill-color and a fill pattern.

20. The method according to claim 19, further comprising:
(F) editing an associative region by modifying a boundary element of said associative region;
(G) removing a display of said associative region;
(H) applying a formation operator indicated by said stored formation operator type to said boundary elements; and
(I) displaying said edited associative region.

21. The method according to claim 20, further comprising:
(J) maintaining an association flag in said associative region indicating the association state of said associative region;
(K) determining if said associative region remains associated after editing by verifying that the associative region is still bounded by said boundary elements;
(L) when said associative region is determined to be associated, setting said association flag to indicate association; and
(M) when associative region is determined to be disassociated, setting said association flag to indicate disassociation, and adding visual highlighting to said display of said associative region to indicate disassociation.

22. The method according to claim 20, wherein:
(F) editing comprises at least one of:
ii. adding a boundary element to said associative region, comprising adding a unique identifier of said boundary element to said associative region's stored list of boundary element identifiers;
ii. deleting a boundary element from said associative region comprising
iia. determining if said boundary element is the only boundary element of said associative region;
iib. when said boundary element is determined not to be the only boundary element of said associative region, removing the unique identifier of said boundary element from said associative region's list of boundary element identifiers;
iic. when said boundary element is determined to be the only boundary element of said associative region, removing said associative region from said graphics file;
iii. changing the location of a boundary element of said associative region;
iv. changing the size of a boundary element of said associative region; and
v. notifying said associative region from said modified boundary element that said modified boundary element has been modified.

23. The method according to claim 1, further comprising:
automatically calculating said associative region's area, when said associative region is two dimensional; and
automatically calculating said associative region's volume, when said associative region is three dimensional.

24. A system that creates and modifies associative regions comprising:
a processor;
a memory coupled to said processor;
an associative region creation and modification module executable on said processor operative to create and modify associative regions wherein said associative region creation and modification module comprises:
a shape selector operative to select a multi-dimensional shape in a graphics file,
a boundary element associator that associates said multi-dimensional shape with an associative region, and
an assignor that assigns a formation operator to an associative region.

25. The system according to claim 24, further comprising:
an parameter assignor that assigns and stores parameters of said associative region in said memory, wherein said parameters comprise at least one of
a formation operator parameter that indicates the method by which said associative region is formed,
a locate interior shapes parameter, and
a locate interior text parameter; and
a display that displays said associative region with at least one of a hatch pattern, a fill-color and a fill pattern.

26. The system according to claim 25, further comprising:
an editor operative to edit said associative region comprising at least one of:
a boundary element adder operative to add a boundary element to said associative region;
a boundary element remover operative to delete a boundary element from said associative region;
a boundary element mover operative to move a boundary element of said associative region;
a boundary element resizer operative to change the size of a boundary element of said associative region; and
a notification module that notifies said associative region when a boundary element has been modified.

27. The system according to claim 26, further comprising:
a highlighter that visually highlights said associative region on said display when said associative region becomes disassociated, and that removes said visual highlights when said associative region becomes re-associated.

28. The system according to claim 24, further comprising:
an associative region selector operative to select an associative region and each boundary element associated with said associative region;
a copier that creates a new associative region with properties identical to said selected associative region and, for each of said selected boundary elements, creates a new boundary element identical to said each selected boundary element, thereby making a copy of said each selected boundary element;
an identifier assignor that assigns a new, unique identifier to said each copy of said selected boundary elements;
said boundary element associator operative to remove all previously stored unique identifiers from said new associative region and to store each said new, unique identifier in said new associative region; and
a paster operative to place said new associative region into at least one of said graphics file and a different graphics file.

29. The system according to claim 24, further comprising:
a seed point adder operative to add a seed point to said associative region;
a boundary element locator that finds and selects all shapes in said graphics file that together form a closest closed boundary around said seed point, wherein said selected shapes are associated by said associator to said associative region; and
wherein said assignor is operative to assign a flood operator.

30. The system according to claim 29, further comprising:
a seed point associator that associates said seed point with said associative region;
a parameter assignor that assigns and stores parameters of said associative region in said memory, wherein said parameters comprise at least one of
a formation operator parameter that indicates the method by which said associative region is formed,
a locate interior shapes parameter, and
a locate interior text parameter; and
a display that displays said associative region with at least one of a hatch pattern, a fill-color and a fill pattern.

31. The system according to claim 30, further comprising:
an editor operative to edit a seed point of said associative region comprising at least one of:
a seed point adder operative to add a seed point to said associative region's list of seed points;
a seed point remover operative to delete a seed point from said associative region;
a seed point mover operative to change the location of a seed point of said associative region;
an updater that automatically locates all of the boundary elements that, combined. form a smallest closed boundary surrounding said associative region's seed points, and automatically associates a located boundary element to said associative region when said located boundary element is not previously associated with said associative region.

32. The system according to claim 31, further comprising:
a highlighter that visually highlights said associative region on said display when said associative region becomes disassociated, and that removes said visual highlights when said associative region becomes re-associated.

33. The system according to claim 24, wherein:
said shape selector is operative to select at least two multi-dimensional shapes and
said assignor is operative to assign at least one of a union, an intersection and a difference formation operator.

34. The system according to claim 33, further comprising:
an parameter assignor that assigns and stores parameters of said associative region in said memory, wherein said parameters comprise at least one of
a formation operator parameter that indicates the operation by which said associative region is formed,
a locate interior shapes parameter, and
a locate interior text parameter; and
a display that displays said associative region with at least one of a hatch pattern, a fill-color and a fill pattern.

35. The system according to claim 34, further comprising:
an editor operative to edit said associative region comprising at least one of:
a boundary element adder operative to add a boundary element to said associative region;
a boundary element remover operative to delete a boundary element from said associative region;
a boundary element mover operative to move a boundary element of said associative region;
a boundary element resizer operative to change the size of a boundary element of said associative region; and
a notifier that notifies said associative region that a boundary element has been modified.

36. The system according to claim 35, further comprising:
a highlighter that visually highlights said associative region on said display when said associative region becomes disassociated, and that removes said visual highlights when said associative region becomes re-associated.

37. The system according to claim 24, further comprising:
a calculator that automatically calculates at least one of an area and a volume of said associative region.

38. A computer program product embodied on a computer readable medium, said computer program product comprising program logic wherein the computer program product comprises:
associative region creation and modification program code means for enabling a processor to create and modify associative regions, further comprising
selecting means for enabling said processor to select a multidimensional shape in a graphics file;
boundary element associating means for enabling said processor to associate said multi-dimensional shape with an associative region, and
assigning means for enabling said processor to assign a formation operator to said associative region.

39. The computer program product according to claim 38, further comprising:
storing means for enabling said processor to store parameters in said associative region, wherein said parameters comprise at least one of
a formation operator parameter indicating the operation by which said associative region is formed,
a locate interior shapes parameter, and
a locate interior text parameter; and
displaying means for enabling said processor to display said associative region with at least one of a hatch pattern, a fill-color and a fill pattern.

40. The computer program product according to claim 39, further comprising:
editing means for enabling said processor to edit said associative region, comprising at least one of:
boundary element adding means for enabling said processor to add a boundary element to said associative region;
boundary element removing means for enabling said processor to delete a boundary element from said associative region;
boundary element moving means for enabling said processor to move a boundary element of said associative region;
boundary element resizing means for enabling said processor to change the size of a boundary element of said associative region; and
notifying means for enabling said processor to notify said associative region that a boundary element has been modified.

41. The computer program product according to claim 40, further comprising:
highlighting means for enabling said processor to visually highlight said associative region on said display when said associative region becomes disassociated, and to remove said visual highlights when said associative region becomes re-associated.

42. The computer program product according to claim 38, further comprising:
selecting means for enabling said processor to select an associative region a n d each boundary element associated with said associative region;
copying means for enabling said processor to create a new associative region with properties identical to said selected associative region and, for each of said selected boundary elements, to create a new boundary element identical to said each selected boundary element, thereby making a copy of said each selected boundary element;
assigning means for enabling said processor to assign a new, unique identifier to each of said copies of said selected boundary elements;
boundary element updating means for enabling said processor to remove all previously stored unique identifiers from said new associative region and to store each said new, unique identifier in said new associative region; and
pasting means for enabling said processor to place said new associative region into at least one of said graphics file and a different graphics file.

43. The computer program product according to claim 38, further comprising:
seed point adding means for enabling said processor to add a seed point to said associative region;
boundary element locating means for enabling said processor to find and select all shapes in said graphics file that together form a closest closed boundary around said seed point, wherein said selected shapes are associated by said boundary element associating means with said associative region; and
wherein said formation operator comprises a flood operation from said seed point to said selected shapes.

44. The computer program product according to claim 43, further comprising:
seed point associating means for enabling said processor to associate said seed point with said associative region; and
storing means for enabling said processor to store parameters in said associative region, wherein said parameters comprise at least one of
a formation operator parameter indicating the operation by which said associative region is formed,
a locate interior shapes parameter, and
a locate interior text parameter; and
displaying means for enabling said processor to display said associative region with at least one of a hatch pattern, a fill-color and a fill pattern.

45. The computer program product according to claim 44, further comprising:
editing means for enabling said processor to edit a seed point of said associative region, comprising at least one of:
seed point adding means for enabling said processor to add a seed point to said associative region's list of seed points;
seed point removing means for enabling said processor to delete a seed point from said associative region;
seed point moving means for enabling said processor to change the location of a seed point of said associative region;
updating means for enabling said processor to automatically locate all of the boundary elements that combine to form a smallest closed boundary surrounding said associative region's seed points and to automatically associate a located boundary element with said associative region when said located boundary element is not previously associated with said associative region.

46. The computer program product according to claim 45, further comprising:
highlighting means for enabling said processor to visually highlight said associative region on said display when said associative region becomes disassociated, and to remove said visual highlights when said associative region becomes re-associated.

47. The computer program product according to claim 38, wherein:
said a formation operator comprises at least one of a union, an intersection and a difference.

48. The computer program product according to claim 47, further comprising:
storing means for enabling said processor to store parameters in said associative region, wherein said parameters comprise at least one of
a formation operator parameter indicating the operation by which said associative region is formed,
a locate interior shapes parameter, and
a locate interior text parameter; and
displaying means for enabling said processor to display said associative region with at least one of a hatch pattern, a fill-color and a fill pattern.

49. The computer program product according to claim 48, further comprising:
editing means for enabling said processor to edit said associative region comprising at least one of:
boundary element adding means for enabling said processor to add a boundary element to said associative region;
boundary element removing means for enabling said processor to delete a boundary element from said associative region;
boundary element moving means for enabling said processor to move a boundary element of said associative region;
boundary element resizing means for enabling said processor to change the size of a boundary element of said associative region; and
notifying means for enabling said processor to notify said associative region that a boundary element has been modified.

50. The computer program product according to claim 49, further comprising:
highlighting means for enabling said processor to visually highlight said associative region on said display when said associative region becomes disassociated, and to remove said visual highlights when said associative region becomes re-associated.

51. The computer program product according to claim 38, further comprising:
calculating means for enabling said processor to automatically calculate at least one of an area and a volume of said associative region.

52. A computer-readable medium containing a data structure for storing an associative region comprising:
a boundary element identifier list containing an entry for each boundary element associated with an associative region, each entry containing a unique identifier for a boundary element;
a seed point list containing an entry for each seed point of said associative region; and
a formation operator parameter containing an constant indicating the formation operation used to generate said associative region.

53. The data structure of claim 52, further comprising:
an association_on flag containing a Boolean value to indicate an association state;
an interior_shapes flag containing a Boolean value to indicate whether interior shapes should be ignored when generating said associative region; and
an interior text flag containing a Boolean value to indicate whether interior text should be ignored when generating said associative region.
